(19) United States
(12) Patent Application Publication
(10) Pub. No.: US 2005/0273834 A1
(43) Pub. Date: Dec. 8, 2005

(54) [World News Network]

(75) Inventor: Jose De Sousa, Walnut Creek, CA (US)

Correspondence Address: J.D. DESOUSA, 780 SILVER OAKS PLACE, WALNUT CREEK, CA, 94596, US

(73) Assignee: Jose De Sousa, Walnut Creek, CA (US)

(21) Appl. No.: 10/605,850

(22) Filed: May 17, 2004

(51) Int. Cl. H04N 7/173; H04N 7/16

(52) U.S. Cl. 725/117; 725/147

(57) ABSTRACT

The method of combing a collection of live news media from countries or cities from around the world which is then broadcast on a single broadcasting channel.

The method of combining a collection of live news media from countries or cities from around the world which is then broadcast on a single broadcasting channel.

### DETAILED DESCRIPTION

This method is where news broadcast is transmitted live in real time on a singe broadcasting channel from countries, cities around the world this can be on a single channel or multiple channels. Countries around the world broadcast their news on their local station if one is in another country one can not view/listen said countries local news. This method allows one to view/listen to news broadcast from different countries or cities in different parts of the world or country

Example with World News Network one who is in the United States of America can view live news broadcast from S.A.B.C. from South Africa and vise versa this news broadcast in South Africa is transmitted at 8:00 p.m. and viewed in San Francisco at 10:00 a.m. and at 11:00 a.m. San Francisco time B.B.C news from the United Kingdom can viewed/listened e.t.c. This method is also used for city news broadcast San Francisco can view New York news and vise versa

This method combines news broadcasting from countries or cities from around the world on a single channel or multiple channels. Viewed live in real time as it been transmitted locally

Transmission is via satellites, internet, radio or any other method currently known or unknown. Media news broadcasting can be television, radio, internet or any other method currently known or unknown

1. I claim the invention of a live broadcasting channel which groups real time news reports from broadcasting media from around the world, which is then transmitted on a single live media channel. Live news media is grouped on a single media broadcasting station such as radio, television, etc., broadcasted live around the world.
Example: News from Portugal, South Africa, Canada, Australia, Netherlands, Brazil. Mexico, China, etc. is transmitted live to a single media channel and then rebroadcast. A viewer in the U.S.A. can view news from S.A.B.C.—South Africa in real time and then after that view R.T.P. news from Portugal, etc.
News reports reported on the hour from around the world news broadcasting media With different time zones around this will permit for reporting different news reports in the countries local time. Therefore allowing WNN to be 24 hours, there are many countries and their fore their will be more than one WNN example WNN-1 will have 24 country national news then the next 24 countries will be on WNN-2.
Politician around the world can watch the local news of said country. Ex-citizens can also watch their old home country news. People in one particular country can now also learn from other countries.
Similar the same can be for local city broadcasting station across a nation such as the U.S.A.
